(19) United States
(12) Patent Application Publication
(10) Pub. No.: US 2010/0189923 A1
(43) Pub. Date: Jul. 29, 2010

(54) METHOD OF FORMING HARDMASK BY PLASMA CVD

(75) Inventor: Kamal Kishore Goundar, Yokohama-shi (JP)

Correspondence Address: Snell & Wilmer L.L.P. (ASM Japan), One Arizona Center, 400 East Van Buren Street, Phoenix, AZ, 85004-2202, US

(73) Assignee: ASM JAPAN K.K., Tokyo (JP)

(21) Appl. No.: 12/362,023

(22) Filed: Jan. 29, 2009

(51) Int. Cl. H05H 1/02

(52) U.S. Cl. 427/570

(57) ABSTRACT

A method of forming a transparent hardmask by plasma CVD includes: providing an underlying layer formed on a substrate in a reaction space; introducing an inert gas into the reaction space; introducing a hydrocarbon precursor vapor of an aromatic compound into the reaction space, wherein a flow ratio of the hydrocarbon precursor vapor to the inert gas is less than 0.1; and applying RF power to the reaction space, thereby depositing on the underlying layer a transparent hardmask having a film stress of −300 MPa to 300 MPa.

### BACKGROUND

1. Field of the Invention

The present invention relates to a method of forming a hardmask constituted by a nano-carbon polymer (NCP) film by plasma CVD.

2. Description of the Related Art

In semiconductor processing techniques, optical films such as antireflective films and hard masks are used. In conventional techniques, these films are formed mainly by a technique called a coating method. The coating method enables forming highly functional polymer films by coating a liquid material and sintering it. It is, however, difficult to form a thin film on a substrate using this method because the liquid to be applied has high viscosity. Furthermore, it is also difficult to control the refractive index and extinction coefficient of the films formed according to the above mentioned coating method. As semiconductor chip sizes continue to shrink, thinner, high-strength and high transparent films are required.

As an advantageous method for achieving formation of such films, formation of a diamond-like carbon (DLC) film or an amorphous carbon film by plasma CVD has been reported (e.g., U.S. Pat. No. 5,470,661, U.S. Pat. No. 6,428,894). In these cases, using a molecule which is gaseous at room temperature as a precursor material, a diamond-like carbon film or an amorphous carbonous film is formed by decomposing the molecule using a plasma. Using a plasma CVD method is promising for facilitating formation of thinner films whereas the refractive index and extinction coefficient can also be controlled.

### SUMMARY

Polymer materials produced from organic monomers such as saturated or unsaturated hydrocarbon can achieve wide varieties of structures and characteristics and can be widely and industrially used as high-strength materials and produce various highly-functional materials. By plasma polymerizing these organic monomers (e.g., by including them in reaction gas as a source gas), it becomes possible to form a thin-film hard mask having excellent mechanical and optical characteristics.

In the above, in CVD where the monomer having a saturated or unsaturated hydrocarbon structure is used, a polymer having a density of about 1.0 g/cm³ or higher and an extinction coefficient of about 0.10 or higher for light having a wavelength of 633 nm can be formed by sufficiently incorporating these structures into the polymer structure.

However, the film obtained according to the plasma CVD method tends to have a relatively high film stress (e.g. highly compressive or highly tensile) which is likely to degrade the film performance when used as a hardmask during the process of pattern transfer from the photo resist to the layer disposed underneath the photo resist. Due to the high film stress of the hardmask, the lines/patterns formed during the process of pattern transfer are apt to be deformed and therefore result in irregular patterns which are herein described as a line wiggle phenomenon.

Line wiggling herein described may refer to a line/pattern having an irregular shape/structure including, but not limited to, a crooked, curving, bent, and/or serpentine shape/structure, and other similar defective or deformed shapes/structures. These structures manifesting the wiggling phenomenon can be illustrated as shown in FIG. 4 and FIG. 5. FIGS. 4 and 5 are top views of the structure shown in FIG. 3. In FIG. 3, a substrate 33 may be composed of multiple layers, and on a top surface of the substrate, an insulating layer 32 that may be an oxide or nitride based film is formed. A hardmask 31 is formed on top of the insulating layer 32, and subjected to etching wherein the hardmask 31 and the insulating layer 32 are etched in a desired pattern. In embodiments, the thickness of the insulating layer may be in a range of 200 to 20,000 nm, and the thickness of the hardmask may be in a range of 10 to 1,000 nm (preferably 50 to 500 nm), depending on the desired aspect ratio. A reliable line profile can be defined as illustrated in FIG. 4, which has dimensions of “a” and “b” with a ratio of “a” to “b” between 0.85 to 1.10, wherein “a” is a width along a shorter side of the pattern (“c” is a length of a longer side of the pattern) and “b” is a maximum width of the pattern. As shown in FIG. 4, if the pattern is a rectangle, the ratio of a/b is one (i.e., a=b). However, if the pattern manifests a wiggling phenomenon, that is an unreliable pattern which has a ratio of a/b outside the range of 0.85 to 1.10. That is, the pattern is reliable when the relationship 0.85a≦b≦1.10a is satisfied. FIG. 5 illustrates an unreliable pattern with a wiggling phenomenon wherein the ratio of a/b is outside the range of 0.85 to 1.10. In some embodiments, the ratio of a/b may be in a range of 0.9 to 1.0. wiggling problem may be significant when “a” is less than 50 nm, especially about 40 nm or less (e.g., typically about 30 nm). The wiggling profile of a hardmask is likely to be transferred to the pattern which will be formed by etching the underlying layer, resulting in pattern distortion. The consequences could be severe; CD (pattern width) distortion can compromise device performance and striations inside vias or other holes and hamper the subsequent metal fill, resulting in increasing resistance or causing catastrophic failure.

It is believed that high film stress is likely to create a relatively high tension in the neighboring layers including layers disposed either on top of or underneath a hardmask film. Furthermore, during the process of pattern transfer, when the hardmask layer having high film stress is etched, during the process of etching, tension applied to the neighboring layers is likely to be released. As a result, it forces the lines to change their shapes in an irregular manner, consequently developing an unreliable line pattern structure or causing a wiggling phenomenon.

Although line wiggling may manifest itself in a manner different from line twisting or line edge irregularity, the line twisting or line edge irregularity may be caused for the same or similar reasons after pattern transfer from a photo resist to the underneath later. Line wiggling or twisting may herein refer to any substantial change in the shape of a line as viewed from top.

Although the mechanism which causes line wiggling or twisting is not specifically known, it can be attributed to the factor mentioned above. In fact, it has been shown that film deposited with high stress can induce wiggling. This may because due to the high tension between different layers, the tension is released during the process of etching, consequently pulling layers including other layers out of shape.

In an embodiment of the present invention, by introducing a hydrocarbon monomer having an aromatic structure such as a benzene structure, a highly stable nano-carbon polymer (NCP) film having a low film stress such as less than 300 MPa can be formed. The forming NCP film can have optical properties such as a refractive index (n) of 1.6 or higher (preferably at least 1.75 or at least 1.80) and an extinction coefficient (k) of 0.1 or lower (preferably 0.05 or lower) for light having a wavelength of 633 nm. Furthermore the film density may be 1.0 g/cm³ or greater. Due to relatively low film stress, high film density with low extinction coefficient and high film stability of the forming NCP film, the line wiggling problem can be alleviated as a result of a reliable pattern transfer. Moreover, the etching selectivity and alignment performance can significantly be improved.

The film stress can be controlled by selecting the type of hydrocarbon precursor that preferably has an aromatic ring which is chemically and thermally stable, and by adjusting the flow ratio of the hydrocarbon precursor to an inert gas which is preferably less than 0.1 (in some embodiments, about 0.03 to about 0.05), thereby depositing the hydrocarbon polymer film having a film stress of less than 300 MPa (preferably less than 200 MPa) either on compressive side or tensile side (preferably on compressive side). As a result, the wiggling problem when used as a hardmask can effectively be eliminated.

The film produced in some embodiments may refer to a NCP film, hydrocarbon-containing polymer film, hydrocarbon-based polymer film, carbon polymer film, polymer film constituted substantially by hydrocarbon, or polymer film derived from a hydrocarbon or carbon precursor. The film is suitable for a hardmask. In an embodiment, a hydrocarbon-containing polymer film is formed on a semiconductor substrate, using a capacitively-coupled plasma CVD apparatus, by a method which comprises: (i) vaporizing a hydrocarbon-containing liquid monomer (C_{α}H_{β}, wherein α and β are natural numbers of 5 or more) having a boiling point of about 20° C. to about 350° C., said liquid monomer having an aromatic (e.g., benzene) structure; (ii) introducing said vaporized gas into a CVD reaction chamber inside which a substrate is placed; and (iii) forming a hydrocarbon-containing polymer film on said substrate by plasma polymerization of said gas.

In an embodiment, the liquid organic monomer consists of hydrocarbon and contains none of O, Si, F, and N in the monomer. In an embodiment, the source gas is exclusively the liquid organic monomer. In an embodiment, in addition to the liquid organic monomer, an inert gas and/or an additive gas are/is used as part of the process gas.

Since most of monomers having high molecular weights have low vapor pressures and are liquid at room temperature, they are vaporized in order to introduce them into a reaction chamber. In an embodiment of the present invention, use of liquid monomers is facilitated by using a vaporizer for vaporizing the liquid monomers, and heating and keeping a given temperature gas piping extending from the vaporizer to a reactor and a shower plate inside a reaction space, and thus inhibiting monomers from re-condensation.

Further, according to an embodiment of the present invention, after being introduced into the reaction chamber, the organic monomers are polymerized by a polymerization reaction by plasma to make it possible to form an organic carbon polymer film on a substrate surface, and it becomes possible to use the film formed as a hardmask for semiconductor processing. A carbon polymer film formed by plasma CVD has excellent characteristics as an optical film because it facilitates forming a thin film having transparency with reliable film stress. Furthermore, the film optical property and the film stress is stable even when it is been exposed to the clean room (CR) atmosphere.

In this disclosure, “gas” may include vapor of solid or liquid.

The present invention is not limited to the above-mentioned advantages, objects or embodiments. In the present invention, it is to be understood that not necessarily all such objects or advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other objects or advantages as may be taught or suggested herein.

### BRIEF DESCRIPTION OF THE DRAWINGS

Figures are referred to when embodiments of the present invention are described, but the present invention is not limited to these figures and embodiments. The figures may be oversimplified for illustrative purposes and are not necessarily to scale.

FIG. 1 is a schematic view showing an example of a CVD apparatus which can be used in an embodiment of the present invention.

FIG. 2 depicts an exemplary sequence (deposition recipe) for forming a NCP film.

FIG. 3 is a schematic cross-sectional view of a portion of the integrated circuit formed during the process of semiconductor device processing.

FIG. 4 is a top view of the integrated circuit portion shown in FIG. 3 showing a feature of a reliable pattern formed without line wiggling in accordance with an embodiment of the present invention.

FIG. 5 is a top view of the integrated circuit portion similar to that shown in FIG. 4 illustrating a wiggling phenomenon with an unreliable line pattern.

### DETAILED DESCRIPTION

The present invention is described in detail using preferred embodiments. The present invention, however, is not limited to these embodiments. Additionally, an element used in an embodiment may be freely applicable to other embodiments, and elements used in different embodiments may mutually or interchangeably be replaceable unless mutually exclusive conditions are employed.

In a method of forming a hydrocarbon-containing polymer film on a semiconductor substrate using a capacitively-coupled plasma CVD apparatus, the disclosed embodiments provide the above-mentioned method which comprises: (i) vaporizing a hydrocarbon-containing liquid monomer (C_{α}H_{β}, wherein α and β are natural numbers of 5 or more); having a boiling point of about 15° C. to about 350° C., said liquid monomer having an aromatic structure; (ii) introducing said vaporized gas into a CVD reaction chamber inside which a substrate is placed; and (iii) forming a hydrocarbon-containing polymer film on said substrate by plasma polymerization of said gas. The substrate is, for example, a semiconductor device substrate with partially fabricated integrated circuits thereon.

In the above embodiment, the aromatic liquid monomer may include mesitylene or benzene. Mesitylene or 1,3,5-trimethylbenzene may be preferable due to its symmetrical structure having structural stability. In an embodiment, 1,3,5-triethylbenzene may be used. In some embodiments, the aromatic liquid monomer may be any compound having an aromatic ring such as a benzene ring, a naphthalene ring, a troplylium ring, a cyclopropenylium ring, a pyridine ring, or a pyrrole ring, each of which may have no substituent or have at least one substituent. Since the hydrocarbon source has an aromatic structure, in the stage of film growth on the semiconductor substrate during a plasma reaction, hydrocarbon source structure is likely to be less dissociated due to strong bonding energy between the atoms which consequently incorporates a large degree of cyclic-like structure in the film. Moreover, due to less dissociation of bonding structure, it minimizes the effect of ion bombardment to the semiconductor substrate and the layer to be deposited which consequently results in the formation of a low stress film. Due to low film stress, high density and low extinction coefficient of the film, line wiggling issue is inhibited while the etching selectivity and alignment performance can be improved.

In any of the foregoing embodiments, the liquid monomer may have a carbon/hydrogen ratio (C/H) of 0.4 or higher, preferably 0.5 or higher. As the liquid monomer, those disclosed in U.S. patent application Ser. No. 11/853,273 which is owned by the same assignee as in the present application can be used in an embodiment, the disclosure of which is incorporated herein by reference in its entirety.

In any of the aforesaid embodiments, said aromatic liquid monomer (which may be referred to as a benzene liquid monomer) may be the only reaction gas used for deposition. In any of the aforesaid embodiments, the aromatic liquid monomer and the inert gas may be the only gases used for deposition. In any of the aforesaid embodiments, the aromatic liquid monomer may consist of a single compound or may consist of a mixture of two or more compounds.

In any of the aforesaid embodiments, the aromatic liquid monomer may be introduced into a vaporizer disposed upstream of said reaction chamber and vaporized. In the above, the aromatic liquid monomer may be flow-controlled upstream of said vaporizer by a valve, and its introduction into said vaporizer may be blocked, except during deposition when a film is being formed, by a shutoff valve disposed between said flow control valve and said vaporizer and kept approximately at 150° C. or lower.

In any of the aforesaid embodiments, the method may further comprise introducing an inert gas into the reaction chamber prior to the plasma polymerization.

In any of the aforesaid embodiments, as an additive gas, an organic gas CnHm (wherein n is an integer of 4 or less including zero; m is any natural number) may further be introduced into the reaction chamber. In any of the aforesaid embodiments, as an additive gas, a dry gas containing any one or two or all of N, O, and F may further be introduced into the reaction chamber.

Additionally, according to another embodiment, in a method of forming a hydrocarbon-containing polymer film on a semiconductor substrate using a capacitively-coupled plasma CVD apparatus, the method comprises the steps of placing a semiconductor device substrate inside a CVD reaction chamber, vaporizing a hydrocarbon-containing liquid monomer (C_{α}H_{β}, wherein α and β are natural numbers of 5 or more) having a boiling point of 15° C. to 350° C. (which may or may not be substituted by a vinyl group or an acetylene group), introducing the vaporized gas into the CVD reaction chamber inside which the substrate is placed, and forming a hard mask composed of a hydrocarbon-containing polymer film on the substrate by plasma polymerizing the gas.

In one or more of the above-mentioned embodiments, the liquid monomer may be introduced into a vaporizer disposed upstream of the reaction chamber and vaporized. Additionally, the liquid monomer may be flow-controlled by a valve upstream of the vaporizer, and introduction of the liquid monomer into the vaporizer may be blocked by a shutoff valve disposed between the flow control valve and the vaporizer and kept at 200° C. or lower or at a temperature lower than that of vaporization by approximately 150° C. or more except during deposition when a polymerized material is formed. Or, the liquid monomer may be flow-controlled by a valve disposed upstream of the vaporizer and kept at 200° C. or lower or at a temperature lower than that of vaporization by approximately 150° C. or more, and at the same time introduction of the liquid monomer into the vaporizer may be blocked except during deposition when a polymerized material is formed.

Also in embodiments using any one of the above-mentioned valves, the liquid monomer may be mixed with an inert gas downstream of the valve and upstream of the vaporizer.

Film Formation Sequences

To deposit a hydrocarbon layer on a 300-mm wafer, for example, a hydrocarbon gas source such as mesitylene and an inert gas such as He and Ar may be introduced into the reaction zone.

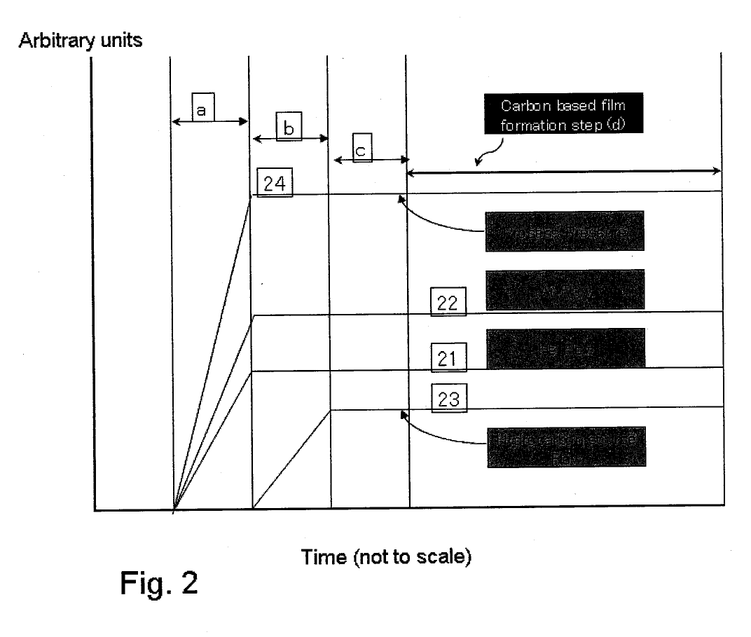

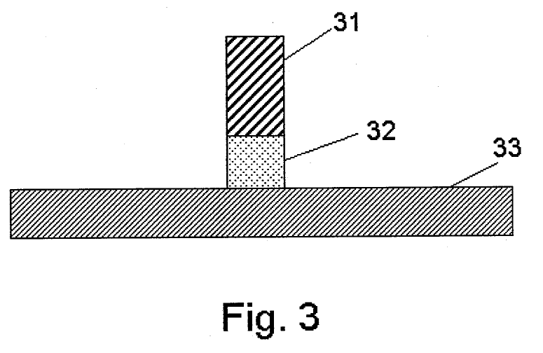

FIG. 2 illustrates an example of the present invention. After a semiconductor substrate is carried into a reaction chamber and is heated at a given temperature in step (a), helium 21 and argon 22, which are an inert gas, are brought into the reaction chamber at a flow rate of 100 sccm to 3,000 sccm, respectively, while controlling the pressure 24 inside the reaction chamber at a value of 100 Pa to 1,000 Pa. In step (b), a hydrocarbon source gas such as mesitylene 23 is brought into the reaction chamber at a flow rate of 50 sccm to 500 sccm. For introducing hydrocarbon source gas, He, and Ar, a linear increasing method in which a flow rate of each gas is increased from zero to a given value at a specific constant rate during predetermined time periods is adopted. In step (c), all of the gas flows become stable, and the pressure is constant. This method is used to prevent floating of particles in the reaction chamber and adhering of contaminant particles to the semiconductor substrate. Such contamination is caused by a rise in a pressure in the reaction chamber resulted from the drastic gas flow into the reaction chamber.

After step (c), once all the gas flows are stabilized, RF power with a frequency of 13.56 MHz is applied in the range of 100 to 3,000 W in step (d) to form a carbon based film having low stress. In this embodiment, the time periods of steps (a), (b), (c), and (d) may be 1-20 sec (step (a)), 1-20 sec (step (b)),1-50 sec (step (c)), and 5-200 sec (step (d)), respectively.

Apparatus Configuration

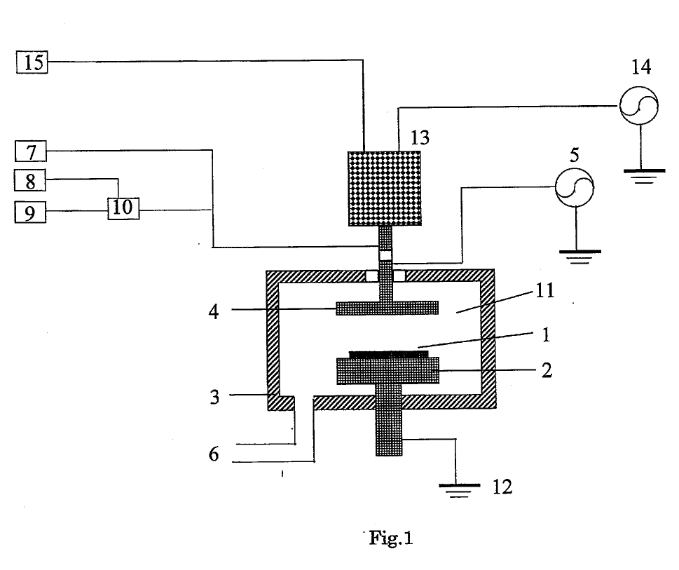

FIG. 1 is a schematic view of an apparatus combining a vaporizer and a plasma CVD reactor, which can be used in an embodiment of the present invention. An apparatus which can be used in the present invention is not limited to an example shown in FIG. 1. Any suitable apparatus can be used.

In this example, by providing a pair of electrically conductive flat-plate electrodes 4, 2 in parallel and facing each other inside a reaction chamber 11, applying RF power 5 to one side, and electrically grounding 12 the other side, plasma is excited between the electrodes. A temperature regulator is provided in a lower stage 2, which serves as the grounded electrode in the example, and temperature is kept constantly at a given temperature in the range of 0° C.-650° C. to regulate a temperature of a substrate 1 placed thereon. An upper electrode 4 serves as a shower plate as well, and reaction gas is introduced distributed into the reaction chamber 11 through the shower plate. Additionally, in the reaction chamber 11, an exhaust pipe 6 is provided through which gas inside the reaction chamber 11 is exhausted. Further, numeral 13 refers to a remote plasma unit, numerals 14 and 15 refer to a remote plasma power source and a gas flow mass control unit, respectively.

A vaporizer 10 that vaporizes a liquid organic monomer has an inlet port for a liquid and an inlet port for an inert gas in an embodiment and comprises a mixing unit for mixing these gases and a unit for heating and/or cooling the mixture. In the embodiment shown in FIG. 1, an inert gas is introduced from an inert gas flow-controller 8 to the vaporizer 10; and a liquid monomer is introduced from a liquid monomer flow-controller 9 into the vaporizer 10. Storage/Processing temperature for the mixture is determined by a vapor pressure characteristic of the liquid monomer; in an embodiment, the temperature is kept in the range of 0° C.-350° C. (e.g., 15° C.-350° C.). Vaporized gas is introduced into the reactor through gas piping. Additionally, the embodiment shown in FIG. 1 is designed to be able to introduce an additive gas including an inert gas from a gas flow-controller 7 into the reactor. Additionally, an inert gas can also be introduced into the reactor without passing through the vaporizer 10. The number of gas flow-controllers 7 can be provided appropriately to meet the number of gas types used.

The piping introducing the gas from the vaporizer to the reactor and a showerhead unit in an upper portion of the reactor are temperature-controlled at a given temperature in the range of 15° C.-350° C. by a vaporizer and their outer side is covered by an insulating material.

Liquid Organic Monomer

In embodiments, the hydrocarbon precursor described above can preferably be used. In some embodiments, the liquid organic monomer used as a source gas comprises a hydrocarbon-containing liquid monomer (C_{α}H_{β}, wherein α and β are natural numbers of 5 or more) having a boiling point of room temperature or higher (e.g., 15° C.-350° C.), which may or may not have a substituent vinyl group or acetylene group. Preferably, the carbon number is 5-30; in an embodiment, the carbon number is 5-12. Additionally, a boiling point is preferably approximately 15° C. to approximately 350° C.; in another embodiment, it is approximately 15° C. to approximately 200° C.; and in still another embodiment, it is approximately 15° C. to approximately 100° C. or higher. The liquid monomer is a cyclic hydrocarbon in an embodiment. The cyclic hydrocarbon can be a benzene or benzene derivative.

The liquid monomer may have a benzene structure, such as mesitylene. In another embodiment, the liquid monomer may have an aromatic structure. As the liquid monomer, a single species or two or more species in various combinations can be used. In any of the foregoing embodiments the liquid monomer may have a carbon and hydrogen ratio of 0.45 or higher, preferably 0.5 or higher.

When the carbon/hydrogen ratio is high, the carbon content in ions or radicals generated by a plasma becomes high, thereby increasing the density of the forming polymer film which can serve as a carbon hard mask. For example, by using C₉H₁₂ (α=9, β=12, C/H=0.75) instead of C₅H₁₂ (α=5, β=12, C/H=0.416), a extinction coefficient the forming polymer film for light having a wavelength of 633 nm can be controlled from 0.005 to 0.1 for light having a wavelength of 633 nm, and a refractive index (n) of the forming polymer film can be controlled from 1.6 to 1.9. This may be because when the liquid monomer having a high C/H ratio is exposed to plasma, the state having a high C/H ratio can be maintained while forming a film, thereby increasing a density.

Furthermore, the film stress is relatively low which is believed to be strongly dependent on the structure of the hydrocarbon source. Since the hydrocarbon source has an aromatic structure, in the stage of film growth on the semiconductor substrate during a plasma reaction, hydrocarbon source structure is likely to be less dissociated due to strong bonding energy between the atoms which consequently incorporates a large degree of cyclic-like structure in the film. Moreover, due to less dissociation of bonding structure, it minimizes the effect of ion bombardment to the semiconductor substrate and the layer to be deposited which consequently results in the formation of a low stress film. Due to low film stress, high density and low extinction coefficient of the film, line wiggling issue is inhibited while the etching selectivity and alignment performance can be improved.

Additionally, in another embodiment, a liquid organic monomer is a hydrocarbon-containing liquid monomer (C_{α}H_{β}, wherein α and β are natural numbers of 5 or more) having a boiling point of room temperature or higher (e.g., approximately 15° C. to approximately 350° C.). Using this monomer, a hard mask is formed. Preferably, the carbon number is 5-30; the carbon number is 5-12 in an embodiment. A boiling point is preferably approximately 15° C. to approximately 350° C.; it is 15° C. to approximately 350° C. in an embodiment; approximately 15° C. to approximately 200° C. in an embodiment. In an embodiment, the liquid monomer is cyclic hydrocarbon.

The details of the process parameters and film forming are explained below.

Carbon Based Polymer Film Formation

As an exemplary process for growing a carbon-based polymer film on a substrate according to an embodiment of the present invention, the parameters listed in TABLES 1 through 3 can be used. Other hydrocarbon precursors and other inert gases can be used in similar manners.

TABLE 1

| | Range |
|---|---|
| Parameters | Film forming Step |
| Mesitylene | 1 sccm~1000 sccm |
| He | 100 sccm~10000 sccm |
| Ar | 100 sccm~10000 sccm |
| Process Pressure | 100 Pa~1000 Pa |
| HRF Power | 100 W~3000 W |
| Substrate Temperature | 200° C.~600° C. |
| Electrode spacing | 1-30 mm |

TABLE 2

| | Range |
|---|---|
| Parameters | Film forming Step |
| Mesitylene | 10 sccm~500 sccm |
| He | 100 sccm~7500 sccm |
| Ar | 100 sccm~7500 sccm |
| Process Pressure | 100 Pa~1000 Pa |
| HRF Power | 100 W~3000 W |
| Substrate Temperature | 200° C.~400° C. |
| Electrode spacing | 5-25 mm |

TABLE 3

| | Range |
|---|---|
| Parameters | Film forming Step |
| Mesitylene | 20 sccm~200 sccm |
| He | 100 sccm~5000 sccm |
| Ar | 100 sccm~5000 sccm |
| Process Pressure | 200 Pa~800 Pa |
| HRF Power | 500 W~2500 W |
| Substrate Temperature | 300° C.~400° C. |
| Electrode spacing | 7-25 mm |

Flow Rate and Other Conditions

A flow rate of the liquid monomer is not particularly restricted, but as a flow rate introduced into a reaction chamber after vaporization, in an embodiment, it is approximately 30 sccm to approximately 1000 sccm (50 sccm, 100 sccm, 150 sccm, 200 sccm, 300 sccm, 400 sccm, 500 sccm, and including a range defined by any one of foregoing values).

Additionally, an inert gas can be introduced into a reaction chamber. For example, the inert gas can be one of or a combination of two or more of Ar, He, Ne, Kr, Xe, and N₂; preferably Ar and/or He. A flow rate of an inert gas introduced into a reaction chamber is approximately 0 sccm to approximately 10000 sccm (30 sccm, 50 sccm, 100 sccm, 150 sccm, 200 sccm, 300 sccm, 500 sccm, 1000 sccm, 2000 sccm, 3000 sccm and including a range defined by any one of foregoing values).

In an embodiment, the carbon based polymer film is formed on the substrate by introducing the hydrocarbon source, inert gas at an equilibrium pressure and applying RF power.

Additionally, in an embodiment, further as an additive gas, an organic gas CnHm (wherein n is an integer of 4 or less including zero; m is any natural number) can also be introduced into a reaction chamber. Or, further as an additive gas, a dry gas containing any one or more or all of N, O, and F can also be introduced into a reaction chamber. Additionally, hydrogen, ammonia, carbon monoxide, etc. can also be used as an additive gas. A flow rate of an additive gas introduced into a reaction chamber is approximately 0 sccm to approximately 300 sccm (30 sccm, 50 sccm, 100 sccm, 150 sccm, 200 sccm, and including a range defined by any one of foregoing values). In an embodiment where the liquid monomer is a benzene monomer, a flow rate of an additive gas introduced into a reaction chamber is approximately 0 sccm to approximately 600 sccm (30 sccm, 50 sccm, 100 sccm, 150 sccm, 200 sccm, 500 sccm, and including a range defined by any one of foregoing values).

Consequently, in an embodiment, an organic carbon polymer film is formed using only a hydrocarbon-containing monomer and an inert gas. Or, the film may be formed using only a hydrocarbon-containing monomer. Additionally, only a hydrocarbon-containing monomer and an inert gas, or a hydrocarbon-containing gas, an inert gas and an additive gas can be used. Additionally, in an embodiment, a flow rate of a gas other than a hydrocarbon-containing monomer is less than that of the hydrocarbon-containing monomer (vapor), preferably less than a half that of the hydrocarbon-containing monomer (vapor).

Additionally, in an embodiment in which an inert gas is mixed in a vaporizer, the inert gas may be introduced into a reaction chamber. The above-mentioned description of inert gas to be introduced into the reaction chamber can apply to the inert gas of the present example. In this case, in substitution for an inert gas introduced directly into the reaction chamber, an inert gas introduced through a vaporizer can be used. Additionally, an inert gas introduced directly into the reaction chamber and an inert gas introduced through the vaporizer can also be used together. In an embodiment, a flow rate of an inert gas introduced through the vaporizer is equal to or more than that of an inert gas introduced directly. Additionally, in an embodiment, the same type of inert gas is used for the one introduced through the vaporizer and the one introduced through the vaporizer; in another embodiment, different types of inert gases are used.

Plasma polymerization can be preformed in an embodiment under the conditions: a substrate temperature of approximately 0° C. to approximately 600° C. (including a range of 150° C.-450° C. and a range of 250° C.-400° C.), a reaction pressure of approximately 10 Pa to approximately 1500 Pa (including a range of 50 Pa to 1000 Pa, a range of 100 Pa to 900 Pa, and a range of 400 Pa to 800 Pa in embodiments). In preferred embodiments, the temperature (measured as the susceptor temperature) may be 400° C. or less, more preferably 350° C.

As to RF power density, a plasma polymerization step is preformed under the conditions of: RF power density of approximately 0.01 W/cm² to approximately 20 W/cm² (per substrate area) (including a range of 0.05-10 W/cm², a range of 1-5 W/cm², and a range of 0.5-5 W/cm² in embodiments).

Power per unit monomer is changed under various other conditions; a plasma polymerization step can be performed under the condition of 0.01-100 W/sccm (including a range of 0.05-50 W/sccm and a range of 3-20 W/sccm) in an embodiment; RF power can also be controlled per monomer unit flow rate. In another embodiment such as where the liquid monomer is a benzene monomer, a plasma polymerization step can be performed under the condition of 0.01-500 W/sccm (including a range of 1-100 W/sccm and a range of 3-50 W/sccm) in an embodiment.

Additionally, a plasma polymerization step can be performed using a frequency exceeding 5 MHz, e.g., any one of high RF (HRF) power of 13.56 MHz, 27 MHz or 60 MHz, in an embodiment; further, one of the foregoing high RF power and low RF (LRF) power of 5 MHz or less (including 2 MHz or less and 500 kHz or less) can be combined. In an embodiment, a ratio of low RF power is 50% or less, 30% or less, or 10% or less of high RF power.

A thickness of an organic polymer can be appropriately selected according to intended uses. In an embodiment, it is 50 nm-1500 nm or 100 nm-1000 nm.

When films are formed using liquid monomers having a C/H ratio of 0.5 or higher, having benzene ring, the films can show significantly improved properties in terms of all of refractive index (RI)(n), extinction coefficient (k), density, modulus, and hardness and film stress. In embodiments, the films may have a RI(n) of 1.6 or higher (e.g., 1.60-2.00), a extinction coefficient (k) of 0.10 or lower (e.g., 0.001-0.05), a density of 1.30 or higher (e.g. 1.30-1.48), a modulus of 20 GPa or higher (e.g., 30-60 GPa), and a hardness of 4 or higher (e.g., 5-10 GPa) and film stress of less than 300 MPa.

Reactor Cleaning and After-Treatment

Additionally, after film formation on a substrate is completed, cleaning inner walls, bottom surface, top surface of a reaction chamber is desirable. For example, cleaning of a desired surface of the reaction chamber can be performed by introducing oxygen (O₂) and/or a mixture gas of CxFy (x and y are any natural numbers respectively) and an inert gas into the reaction chamber and generating plasma between electrodes; after film formation on a substrate is completed, cleaning of a wall surface of the reaction chamber can be performed by introducing a gas containing radical molecules containing O and/or F into the reaction chamber; or after film formation on a substrate is completed, cleaning of a wall surface of the reaction chamber can be performed by introducing a gas containing radical molecules containing O and/or F into a reaction chamber, generating plasma between electrodes.

Additionally, after cleaning a wall surface of the reaction chamber is completed, fluoride on the wall surface of the reaction chamber can be removed by introducing a reducing gas and reducing radical molecules into the reaction chamber and generating plasma between electrodes.

Additionally, during the process of cleaning a wall surface of the reaction chamber using fluorine based gas chemistry technique, fluorine based residue is likely to be generated on the wall surface of the reaction chamber. These unwanted residues can be removed by introducing a reduction gas and reduction radical molecules into the reaction chamber and generating plasma between electrodes.

Further, in order to improve mechanical strength of a film, heat curing of the film formed can be performed by combining ultraviolet light (UV) and electron beam (EB).

In the present disclosure where conditions and/or structures are not specified, the skilled artisan in the art can readily provide such conditions and/or structures, in view of the present disclosure, as a matter of routine experimentation.

Also, in the present disclosure, the numerical numbers applied in embodiments can be modified by ±50% in other embodiments, and the ranges applied in embodiments may include or exclude the endpoints.

Experimental Result

Examples of the disclosed embodiments are explained below, but the present invention is not limited to these examples.

Common conditions: Common conditions in respective examples are as follows: Eagle-12™ (commercially available from ASM Japan of Tokyo Japan) possessing a basic structure shown in FIG. 1 was used as a reactor. Additionally, in the case of these examples, although a liquid monomer was flow-controlled by a flow control unit in a liquid phase, an amount of gas introduced into a reactor was obtained by molar conversion from the flow rate of the liquid.

Reactor Settings

Temperature of upper electrode (shower plate): 180° C.

Temperature of reactor wall: 180° C.

Size of shower plate: φ325 mm (Size of substrate: φ300 mm)

Gap between shower plate and susceptor: 16 mm

The temperature of the vaporizer and that of the piping were selected based on the boiling point, the vaporizing pressure, etc. of the precursor used.

Each hardmask was deposited on a insulating film which was a nitride based film (SiN) having a thickness of 200 nm. Process conditions and film formation results are shown as follows:

TABLE 4
Process parameter and set points for SiN film:

| Parameters | Variables |
|---|---|
| SiH4 | 141 sccm |
| He | 750 sccm |
| Ar | 300 sccm |
| N2 | 4.0 slm |
| Process Pressure | 300 Pa |
| HRF Power | 80 W |
| Substrate Temperature | 400° C. |
| Electrode spacing | 20 mm |

Film Formation Results:

Thickness: 200±10 nm

RI(n)@633 nm: 1.95

RI(n)@248 nm: 2.23

Extinction coefficient(k)@248 nm: 0.182

Film Stress: −350 MPa

### EXAMPLE 1

### Comparative

Process conditions in this example and film formation results are shown as follows: In this example, a non-aromatic hydrocarbon, cyclopentene, was used as a hydrocarbon precursor.

TABLE 5
Process parameter and set points:

| Parameters | Basic film forming Step |
|---|---|
| Cyclopentene | 120 sccm |
| He | 400 sccm |
| Ar | 2000 sccm |
| Process Pressure | 500 Pa |
| HRF Power | 1800 W |
| Substrate Temperature | 340° C. |
| Electrode spacing | 16 mm |

He supplied to vaporizer: 500 sccm

Temperature of vaporizer, vaporizer portion: 150° C.

Controlled temperature of gas inlet piping: 150° C.

Film Formation Results:

Thickness: 200±10 nm

Refractive Index (RI)(n)@633 nm: 1.89

Extinction coefficient (k)@633 nm: 0.08

Film Stress: −338 MPa

Modulus: 43.20 GPa

Hardness: 6.3 GPa

The film formed using above conditions shows fairly good film properties. However, it has a poor film stress performance.

### EXAMPLE 2

Process conditions in this example were the same as in Example 1 except that the hydrocarbon source was changed to mesitylene.

TABLE 6
Process parameter and set points:

| Parameters | Basic film forming Step |
|---|---|
| Mesitylene | 120 sccm |
| He | 400 sccm |
| Ar | 2000 sccm |
| Process Pressure | 500 Pa |
| HRF Power | 1800 W |
| Substrate Temperature | 340° C. |
| Electrode spacing | 16 mm |

Film Formation Results:

Thickness: 200±10 nm

RI(n)@633 nm: 1.8

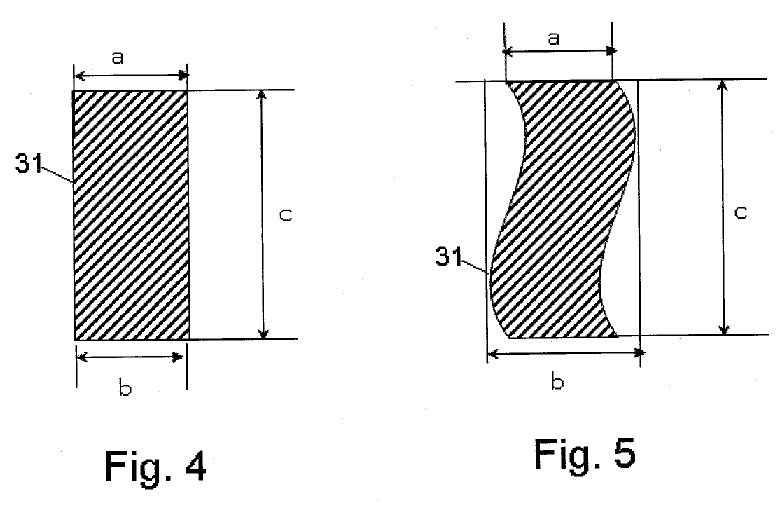

Extinction coefficient (k)@633 nm: 0.04 (see FIG. 4)

Film Stress: −174 MPa

Modulus: 34.3 GPa

Hardness: 5.14 GPa

The film formed using an embodiment of the present invention (Example 2) shows excellent film properties as a hardmask. Furthermore, the film stress is relatively low such as below 200 MPa which is believed to be strongly dependent on the structure of the hydrocarbon source.

### EXAMPLES 3-5

In addition to the basic film properties, the films are characterized by a function of film stress and line profile. Carbon-based polymer films were formed in a manner similar to those used in Examples 1 and 2 as follows:

TABLE 7
Process parameter and set points of Example 3 (Comparative)

| Parameters | Basic film forming Step |
|---|---|
| Cyclopentene | 120 sccm |
| He | 400 sccm |
| Ar | 3000 sccm |
| Process Pressure | 500 Pa |
| HRF Power | 2500 W |
| Substrate Temperature | 340° C. |
| Electrode spacing | 16 mm |

The obtained film had a film stress of −400 MPa.

TABLE 8
Process parameter and set points of Example 4

| Parameters | Basic film forming Step |
|---|---|
| Mesitylene | 120 sccm |
| He | 400 sccm |
| Ar | 3000 sccm |
| Process Pressure | 500 Pa |
| HRF Power | 2500 W |
| Substrate Temperature | 340° C. |
| Electrode spacing | 16 mm |

The obtained film had a film stress of −200 MPa.

TABLE 9
Process parameter and set points of Example 5

| Parameters | Basic film forming Step |
|---|---|
| Mesitylene | 120 sccm |
| He | 400 sccm |
| Ar | 3500 sccm |
| Process Pressure | 500 Pa |
| HRF Power | 2500 W |
| Substrate Temperature | 340° C. |
| Electrode spacing | 16 mm |

The obtained film had a film stress of −250 MPa.

After the carbon-based polymer film was formed on the SiN film according to each of Examples 1-5, the film was subjected to fluorine-based etching for pattern transfer to form a line having a target line width of 30 nm.

The results are shown in Table 10. As can be seen from Table 10, the line wiggling phenomenon is highly correlated to the film stress. Films having a compressive stress of 300 MPa and below (≧−300 MPa) show that the wiggling phenomenon was well controlled whereas the films with a compressive stress of greater than 300 MPa (<−300 MPa) show that the wiggling phenomenon was significant.

TABLE 10
Line wiggling and film stress

| | Line width Target (nm) | | | | |
|---|---|---|---|---|---|
| | 30 nm | | | | |
| | Example | | | | |
| | 2 | 4 | 5 | 1 | 3 |
| Film Stress | −174 | −200 | −250 | −338 | −400 |
| (MPa) | | | | | |
| Δ line width | 0.6 | 2.3 | 4.1 | 5.6 | 10 |
| (a-b) nm | | | | | |
| a/b ratio | 0.98 | 0.93 | 0.88 | 0.84 | 0.75 |
| (Target 0.9~1.10) | | | | | |
| Wiggling observation | no | no | no | yes | yes |
| (judgment) | | | | | (critical) |

The present invention includes the above mentioned embodiments and other various embodiments including the following:

1) A method of forming a transparent hydrocarbon-based film on a substrate by plasma CVD having a low film stress either compressive or tensile within the range of −300 MPa to 300 MPa, comprising: a film formation step, where a film is formed on a substrate by using a hydrocarbon source (C_{α}H_{β}, wherein α and β are natural numbers) in a way such that the depositing film has a film stress of −300 MPa to 300 MPa.

2) The method of 1), wherein the hydrocarbon film has a thickness of between 10 and 100 nm.

3) The method of 1), wherein the film formed is highly transparent and has an extinction coefficient of above 0.001 for light having a wavelength of 633 nm.

4) The method of 1), wherein the processing temperature is above room temperature (such as above 25° C.).

5) The method of 1), wherein the hydrocarbon gas is a vapor phase of a hydrocarbon liquid monomer (Cα Hβ, wherein α and β are natural numbers

6) The method of 1), wherein the hydrocarbon gas is a vapor phase of a hydrocarbon liquid monomer (C_{α}H_{β}, wherein α and β are natural numbers of 5 or more) having a boiling point of about 20° C. to about 350° C.

7) The method of 5), wherein the liquid monomer has a carbon/hydrogen ratio (C/H) of 0.5 or higher.

8) The method of 1), wherein forming the hydrocarbon-based polymer film is conducted at a pressure of less than 1000 Pa.

9) The method of 1), wherein the flow ratio and the processing temperature are controlled, thereby forming the hydrocarbon-based polymer film having an extinction coefficient of less than 0.1 as measured for light having a wavelength of 633 nm.

10) The method of 1), wherein forming the hydrocarbon-based polymer film is conducted under at an RF power density of about 0.01 W/cm² to about 20 W/cm².

11) The method of 5), wherein the liquid monomer is cyclic.

12) The method of 11), wherein the liquid monomer is mesitylene.

13) The method of 11), wherein the liquid monomer is benzene.

14) The method of 1), further comprising introducing as an additive gas an organic gas CnHm (wherein n is an integer of 4 or less including zero; m is any natural number) into the reaction chamber.

15) The method of 1), wherein further comprising introducing as an additive gas a dry gas containing any one or more or all of N, O, and F is into the reaction chamber.

16) The method of 1), wherein the film is a polymer film having a density of more than 1.0 g/cm³.

17) The method of 1), wherein the film is a polymer film having an Elastic Modulus of more than 1 GPa.

18) The method of 1), wherein the film is a polymer film having a refractive index (n) of 1.6 or higher for light having a wavelength of 633 nm.

19) The method of 1), wherein the film is a hard mask for patterning the layer underneath during the process of fabricating semiconductor devices.

It will be understood by those of skill in the art that numerous and various modifications can be made without departing from the spirit of the present invention. Therefore, it should be clearly understood that the forms of the present invention are illustrative only and are not intended to limit the scope of the present invention.

What is claimed is:

1. A method of forming a transparent hardmask by plasma CVD, comprising:
providing an underlying layer formed on a substrate in a reaction space;
introducing an inert gas into the reaction space;
introducing a hydrocarbon precursor vapor of an aromatic compound into the reaction space, wherein a flow ratio of the hydrocarbon precursor vapor to the inert gas is less than 0.1; and
applying RF power to the reaction space, thereby depositing on the underlying layer a transparent hardmask having a film stress of −300 MPa to 300 MPa.

2. The method according to claim 1, wherein the flow ratio of the hydrocarbon precursor vapor to the inert gas is 0.05 or less.

3. The method according to claim 1, wherein the aromatic compound has a carbon/hydrogen ratio (C/H) of 0.5 or higher.

4. The method according to claim 1, wherein the aromatic compound has a benzene structure.

5. The method according to claim 4, wherein the liquid monomer is mesitylene.

6. The method according to claim 1, wherein the hardmask has a compressive film stress of −300 MPa or less as an absolute value.

7. The method according to claim 1, further comprising patterning the hardmask by etching to have a line width of less than 50 nm.

8. The method according to claim 1, wherein the hardmask has a thickness between 10 and 1,000 nm.

9. The method according to claim 1, wherein the hardmask has an extinction coefficient of 0.001 to 0.1 for light having a wavelength of 633 nm.

10. The method according to claim 1, wherein the hardmask has a refractive index (n) of 1.6 or higher for light having a wavelength of 633 nm.

11. The method according to claim 1, wherein the hardmask has an elastic modulus of more than 1 GPa.

12. The method according to claim 1, wherein the substrate is controlled at a temperature of about 25° C. or higher during the deposition.

13. The method according to claim 1, wherein the RF power is applied at a density of about 0.01 W/cm² to about 20 W/cm².

14. The method according to claim 1, further comprising introducing as an additive gas an organic gas CnHm (wherein n is an integer of 4 or less including zero; m is any natural number) into the reaction space.

15. The method according to claim 1, further comprising introducing as an additive gas a dry gas containing any one or more or all of N, O, and F into the reaction space.
